(19) United States
(12) Patent Application Publication
(10) Pub. No.: US 2023/0250029 A1
(43) Pub. Date: Aug. 10, 2023

(54) COMPOSITES AND METHODS OF FORMING COMPOSITES HAVING TAILORED CTE

(71) Applicant: ROHR, INC, Chula Vista, CA (US)

(72) Inventors: PAUL E. KUKUCHEK, San Diego, CA (US); VIJAY V. PUJAR, Rancho Santa Fe, CA (US)

(73) Assignee: ROHR, INC, Chula Vista, CA (US)

(21) Appl. No.: 17/864,174

(22) Filed: Jul. 13, 2022

Related U.S. Application Data
(60) Provisional application No. 63/286,468, filed on Dec. 6, 2021.

(51) Int. Cl. C04B 35/83

(52) U.S. Cl. CPC C04B 35/83; C04B 2235/5244; C04B 2235/5248; C04B 2235/5256; C04B 2235/9607

(57) ABSTRACT

A composite structure formed of a fiber reinforced composite material may include a plurality of fiber layers and a carbon matrix surrounding the plurality of fiber layers. A first fiber layer of the plurality of fiber layers may include a carbon fiber tow. A second fiber layer of the plurality of fiber layers may include a non-carbon fiber tow. The coefficient of thermal expansion of the non-carbon fiber tow is greater than the coefficient of thermal expansion of the carbon fiber tow.

### CROSS-REFERENCE TO RELATED APPLICATIONS

This application claims priority to, and the benefit of, U.S. Provisional Application No. 63/286,468, filed Dec. 6, 2021 and titled “COMPOSITES AND METHODS OF FORMING COMPOSITES HAVING TAILORED CTE,” which is incorporated by reference herein in its entirety for all purposes.

### FIELD

The present disclosure relates to composites, and more specifically, to composite parts having a tailored coefficient of thermal expansion (CTE).

### BACKGROUND

Carbon/carbon (“C/C”) composites consist of carbon fibers in a carbon matrix. C/C composites are used to form parts in various industries. For example, C/C parts may be employed in aerospace applications due to the superior high temperature characteristics of C/C. However, carbon fiber is unique in that it has a negative CTE. Differences in the expansion of a C/C part and the expansion of a component mounted to the C/C part, due to the CTE of C/C part being different from the CTE of the component, can generate stress, which may lead to separation and/or damage to the parts. Similarly, variations in the expansion of a C/C part and a coating applied to the C/C part can lead to cracks in the coating. Finally, the accuracy of aerospace guidance and/or dimensionally stable equipment can be affected by thermal expansion of the structure to which the equipment is attached.

### SUMMARY

A composite structure is disclosed herein. In accordance with various embodiments, the composite structure may comprise a fiber reinforced composite material including a plurality of fiber layers and a carbon matrix surrounding the plurality of fiber layers. A first fiber layer of the plurality of fiber layers includes a first carbon fiber tow, and a second fiber layer of the plurality of fiber layers includes a non-carbon fiber tow. The first carbon fiber tow has a first coefficient of thermal expansion. The non-carbon fiber tow has a second coefficient of thermal expansion that is greater than the first coefficient of thermal expansion.

In various embodiments, the second fiber layer further includes a second carbon fiber tow having the first coefficient of thermal expansion. In various embodiments, the non-carbon fiber tow of the second fiber layer is at least one of a silicon carbide fiber or a silicon nitride fiber.

In various embodiments, the plurality of fiber layers includes a plurality of carbon fiber layers interleaved with a plurality of non-carbon fiber layers. The plurality of carbon fiber layers includes the first fiber layer, and the plurality of non-carbon fiber layers includes the second fiber layer.

In various embodiments, a first portion of the fiber reinforced composite material comprises a first number of fiber layers, and a second portion of the fiber reinforced composite material comprises a second number of fiber layers greater than the first number of fiber layers.

In various embodiments, a fastener is located through the second portion of the fiber reinforced composite material, and a coefficient of thermal expansion of the fiber reinforced composite material in the second portion of the fiber reinforced composite material is approximately equal to a coefficient of thermal expansion of the fastener.

In various embodiments, a coefficient of thermal expansion of the fiber reinforced composite material in the first portion of the fiber reinforced composite material is different from a coefficient of thermal expansion of the fiber reinforced composite material in the second portion of the fiber reinforced composite material.

In various embodiments, a coating may be applied over the fiber reinforced composite material. The coefficient of thermal expansion of the fiber reinforced composite material is approximately equal to a coefficient of thermal expansion of the coating. In various embodiments, a coefficient of thermal expansion of the fiber reinforced composite material is approximately zero.

A method of making a composite structure for use in conjunction with an aerospace component having a target coefficient of thermal expansion is also disclosed herein. In accordance with various embodiments, the method may comprise forming a fiber reinforced composite material by stacking a plurality of fiber layers and forming a carbon matrix surrounding the plurality of fiber layers. The plurality of fiber layers includes a plurality of carbon fibers and a plurality of non-carbon fibers. The carbon fibers of the plurality of carbon fibers have a first coefficient of thermal expansion. The non-carbon fibers of the plurality of non-carbon fibers have a second coefficient of thermal expansion. The second coefficient of thermal expansion is greater than the first coefficient of thermal expansion. A coefficient of thermal expansion of a least a portion of the fiber reinforced composite material is approximately equal to the target coefficient of thermal expansion of the aerospace component.

In various embodiments, a first fiber layer of the plurality of fiber layers includes a first carbon fiber tow having the first coefficient of thermal expansion, and a second fiber layer of the plurality of fiber layers includes a non-carbon fiber tow having the second coefficient of thermal expansion.

In various embodiments, the method further comprises forming the second fiber layer by weaving the non-carbon fiber tow with a second carbon fiber tow having the first coefficient of thermal expansion.

In various embodiments, stacking the plurality of fiber layers includes interleaving a plurality of carbon fiber layers with a plurality of non-carbon fiber layers.

In various embodiments, the method further comprises forming each fiber layer of the plurality of fiber layers by weaving a carbon fiber tow having the first coefficient of thermal expansion with a non-carbon fiber tow having the second coefficient of thermal expansion.

In various embodiments, stacking the plurality of fiber layers includes forming a first portion of the fiber reinforced composite material having a first number of fiber layers and forming a second portion of the fiber reinforced composite material having a second number of fiber layers greater than the first number of fiber layers. The second portion of the fiber reinforced composite material includes the coefficient of thermal expansion that is approximately equal to the target coefficient of thermal expansion of the aerospace component. In various embodiments, the aerospace component is formed of at least one of a metal or a metal alloy.

In various embodiments, the method further comprises dispersing a plurality of ceramic particles in the carbon matrix of the fiber reinforced composite material.

An aerospace component is also disclosed herein. In accordance with various embodiments, the aerospace component comprises a first structure formed of a first material, and a fiber reinforced composite structure mounted to the first structure. The first material comprises at least one of a metal or a metal alloy, a coefficient of thermal expansion of the fiber reinforced composite structure is approximately equal to a coefficient of thermal expansion of the first material.

In various embodiments, the fiber reinforced composite structure includes a plurality of carbon fibers, a plurality of second fibers having a coefficient of thermal expansion greater than a coefficient of thermal expansion of the carbon fibers, and a carbon matrix surrounding the plurality of carbon fibers and the plurality of second fibers. In various embodiments, a plurality of ceramic particles is dispersed in the carbon matrix.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 illustrates an aerospace component including a composite structure formed of fiber reinforced composite material having a tailored CTE, in accordance with the various embodiments;

FIG. 2 illustrates a fiber layup for forming the fiber reinforced composite material of the composite structure in FIG. 1, in accordance with the various embodiments;

FIGS. 3A and 3B illustrate a perspective view and a cross-sectional view, respectively, of an aerospace component including a composite structure formed of fiber reinforced composite material, in accordance with various embodiments; and

FIGS. 4A and 4B illustrate a method of making a composite structure having a tailored CTE, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical changes and adaptations in design and construction may be made in accordance with this invention and the teachings herein. Thus, the detailed description herein is presented for purposes of illustration only and not of limitation. The scope of the invention is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

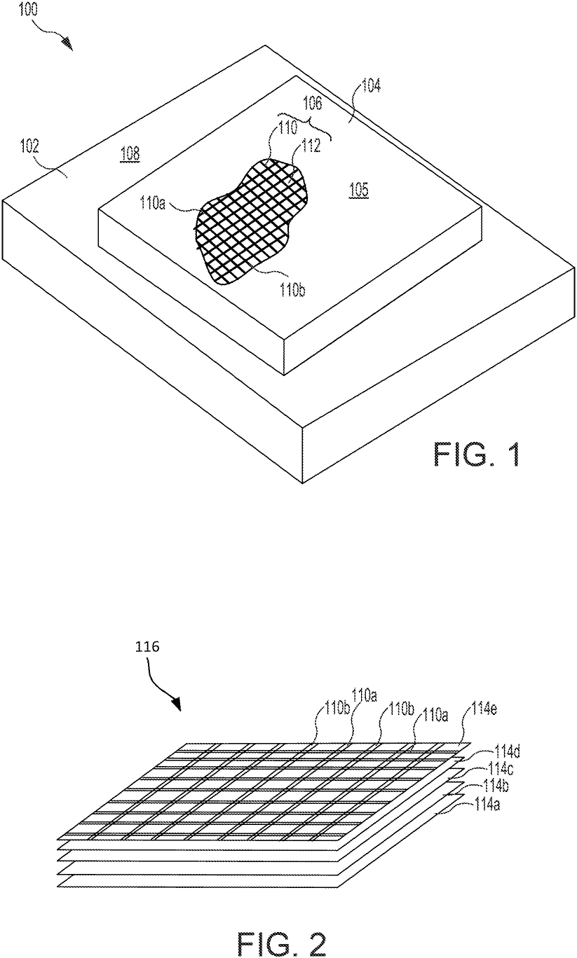

With reference to FIG. 1, an aerospace component 100 is illustrated. In various embodiments, aerospace component 100 includes a first structure 102 and a composite structure 104 mounted to the first structure 102. A composite structure 104 is formed of a fiber reinforced composite material 106. In various embodiments, a coating 105 may be applied over fiber reinforced composite material 106. First structure 102 is formed of a first material 108. In various embodiments, first material 108 may be a metal or a metal alloy. For example, first material 108 may be titanium, a titanium-alloy, a nickel-alloy, or a nickel-based super alloy, such as INCONEL.

In accordance with various embodiments, a CTE of the fiber reinforced composite material 106 of composite structure 104 is tailored to match a target CTE. Stated differently, the CTE of fiber reinforced composite material 106 may be approximately equal to the target CTE. As used in the previous context only, “approximately equal” means the CTE of fiber reinforced composite material 106 is within ± 5.0% of the target CTE. In various embodiments, the target CTE is the CTE of first material 108. In various embodiments, the targe CTE is the CTE of coating 105. In various embodiments, the target CTE is zero.

In accordance with various embodiments, fiber reinforced composite material 106 includes fibers 110 and a matrix 112 surrounding fibers 110. In accordance with various embodiments, fibers 110 include a plurality of carbon (or first) fibers 110a and a plurality of non-carbon (or second) fibers 110b. As used herein, “carbon fiber” refers to a fiber that is formed essentially of only carbon (e.g., a fiber that is at least 90% carbon, at least 95% carbon, at least 98% carbon, at least 99% carbon, at least 99.5% carbon, and/or at least 99.8% carbon). As used herein, “non-carbon fiber” refers to a fiber that includes elements other than, or in addition to, carbon. In this regard, “non-carbon” does not mean devoid of carbon. For example, in various embodiments, non-carbon fibers 110b include silicon carbide (SiC) fibers. In various embodiments, non-carbon fibers 110b include silicon nitride fibers. In accordance with various embodiments, non-carbon fibers 110b have a CTE that is greater than the CTE of carbon fibers 110a. For example, non-carbon fibers 110b may have a CTE of greater than 2.5 × 10⁻⁶/C.

In various embodiments, fiber reinforced composite material 106 includes a plurality of stacked fiber layers. With additional reference to FIG. 2, in various embodiments, fiber reinforced composite material 106 may be formed by stacking a plurality of fiber layers, such as, first fiber layer 114a, second fiber layer 114b, third fiber layer 114c, fourth fiber layer 114d, and fifth fiber layer 114e (collectively fiber layers 114) to form a fiber layup 116. Fiber layers 114 include carbon fibers 110a (also referred to as carbon tows) and non-carbon fibers 110b (also referred to a non-carbon tows).

Fiber layup 116 may be formed utilizing either oxidized polyacrylonitrile (PAN) fibers (referred to as “OPF” fibers) or carbonized carbon fibers for carbon fibers 110a. Carbon fibers 110a and non-carbon fibers 110b are used to fabricate a preform using a needle punching process. For example, carbon fibers 110a and non-carbon fibers 110b are layered in a selected orientation to form fiber layup 116 of a selected geometry. Typically, two or more layers of fibers are layered onto a support and are then needled together simultaneously or in a series of needling steps. This process interconnects the horizontal fibers with a third direction (also called the z-direction). The fibers extending into the third direction are also called z-fibers. This needling process may involve driving a multitude of barbed needles into the fibrous layers to displace a portion of the horizontal fibers into the z-direction.

In various embodiments, at least one of the fiber layers 114 includes both carbon fiber 110a and non-carbon fiber 110b. For example, in various embodiments, at least one of the fiber layers 114 may include a woven fiber layer having a weft formed of carbon fiber 110a and warps formed of non-carbon fiber 110b.

In various embodiments, one or more of fiber layers 114 may include a woven fiber layer, where the weft fibers are non-carbon fibers and the warp fibers are carbon fibers. In various embodiments, one or more of fiber layers 114 may include a woven fiber layer, where the weft fibers include non-carbon fibers and carbon fiber and the warp fibers are carbon fibers. In various embodiments, one or more of fiber layers 114 may include a woven fiber layer, where the warp fibers include non-carbon fibers and carbon fibers and the weft fibers are carbon fibers. In various embodiments, one or more of fiber layers 114 may include a woven fiber layer, where the weft fibers and the warp fibers each include non-carbon fibers interleaved with carbon fibers. The weaving pattern of the carbon and non-carbon fibers of the weft fibers and/or of the warp fibers is/are selected based on the target CTE. In this regard, the weft fibers and/or the warp fibers may include multiple carbon fiber tows between adjacent non-carbon fiber tows and/or multiple non-carbon fiber tows between adjacent carbon fiber tows. In various embodiments, each of the fiber layers 114 is woven with both carbon fibers 110a and non-carbon fibers 110b.

In various embodiments, at least one the fiber layers 114 is formed of only carbon fiber tows 110a (i.e., is devoid of non-carbon fibers 110b) and at least one of the fiber layers 114 is formed of only non-carbon fiber tows 110b (i.e., is devoid of carbon fibers 110a). For example, fiber layup 116 may include non-carbon fiber layers interleaved with carbon fiber layers. In various embodiments, fibers layers 114 may include at least one fiber layer 114 formed of only carbon fiber tows 110a and at least one fiber layer 114 formed of weaved carbon fiber tow 110a and non-carbon fiber tow 110b.

After stacking the desired number of fiber layers 114, fiber layup 116 is densified. Returning to FIG. 1, during the densification operation, carbon matrix 112 is deposited around and between the fibers 110a, 110b. Densification may be done using chemical vapor infiltration (CVI) or any other suitable carbon deposition method.

In accordance with various embodiments, the locations of carbon fibers 110a and non-carbon fibers 110b, the weave pattern of carbon fibers 110a and non-carbon fibers 110b in each fiber layer 114 (FIG. 2), and/or the ratio of carbon fibers 110a to non-carbon fibers 110b is/are selected to create a desired CTE profile through fiber reinforced composite material 106. In this regard, the locations of carbon fibers 110a and non-carbon fibers 110b, the weave pattern of carbon fibers 110a and non-carbon fibers 110b, and/or the ratio of carbon fibers 110a to non-carbon fibers 110b are configured such that the CTE of fiber reinforced composite material 106 is approximately equal the target CTE.

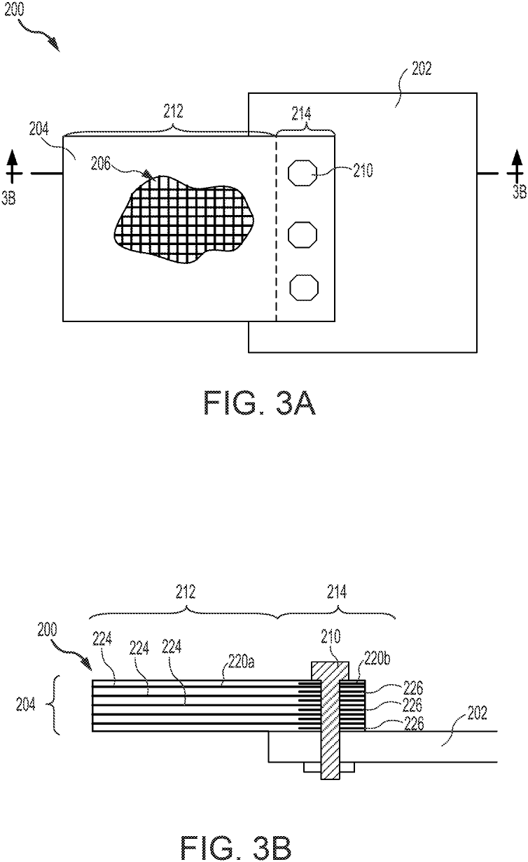

With reference to FIGS. 3A and 3B, an aerospace component 200 is illustrated. In various embodiments, aerospace component 200 includes a first structure 202 and a composite structure 204 mounted to the first structure 202. Composite structure 204 is formed of a fiber reinforced composite material 206. One or more fastener(s) 210 is/are located through fiber reinforced composite material 206. In accordance with various embodiments, the CTE profile of fiber reinforced composite material 206 is configured such that a first portion 212 of fiber reinforced composite material 206 includes a first CTE and a second portion 214 of fiber reinforced composite material 206 includes a second CTE, different from the first CTE. In various embodiments, the CTE of second portion 214 is approximately equal to the CTE of fasteners 210. Fasteners 210 may be formed of a metal or metal alloy. For example, fasteners 210 may include titanium, a titanium-alloy, a nickel-alloy, and/or a nickel-based super alloy, such as INCONEL.

Fiber reinforced composite material 206 includes carbon fibers 220a and non-carbon fibers 220b, which are similar to previously described carbon fibers 110a and non-carbon fibers 110b, respectively. In various embodiments, a ratio of carbon fibers 220a to non-carbon fibers 220b is greater in first portion 212 as compared to the ratio of carbon fibers 220a to non-carbon fibers 220b in second portion 214. For example, the weft fibers and/or the warp fibers in second portion 214 may include a greater ratio of non-carbon fibers 220b to carbon fibers 220a as compared to the ratio of non-carbon fibers 220b to carbon fibers 220a in first portion 212. Stated differently, in various embodiments, a greater percentage of the fibers located in second portion 214 may be non-carbon fibers 220b as compared to the percentage of fibers in first portion 212 that are non-carbon fibers 220b.

In various embodiments, fiber reinforced composite material 206 may be formed by forming a fiber layup, as described above with reference to fiber layup 116. Fiber reinforced composite material 206 may be formed by stacking a plurality of first fiber layers 224 and a plurality of second fiber layers 226. In various embodiments, second fiber layers 226 are located in second portion 214. In this regard, a greater number of fiber layers may be located in second portion 214 as compared to the number of fiber layers in first portion 212. In various embodiments, one or more of the second fiber layers 226 include(s) only non-carbon fibers 220b and one or more of the first fiber layers 224 include(s) only carbon fibers 220a. In various embodiments, one or more of the second fiber layers 226 include(s) non-carbon fibers 220b and carbon fibers 220a, and one or more of the first fiber layers 224 include(s) only carbon fibers 220a. In various embodiments, one or more of the second fiber layers 226 include(s) only non-carbon fibers 220b, and one or more of the first fiber layers 224 include(s) carbon fibers 220a and non-carbon fibers 220b. In various embodiments, one or more of the first fiber layers 224 and one or more of the second fiber layers 226 each include both carbon fibers 220a and non-carbon fibers 220b.

The interleaving pattern of second fiber layers 226 and first fiber layers 224 and the ratio of carbon fibers 220a to non-carbon fibers 220b in second portion 214 is selected based on the CTE of fastener 210. In this regard, the locations of carbon fibers 220a and non-carbon fibers 220b, a weave pattern of carbon fibers 220a and non-carbon fibers 220b, and the ratio of carbon fibers 220a to non-carbon fibers 220b in second portion 214 of fiber reinforced composite material 206 are selected such that the CTE of fiber reinforced composite material 206 in second portion 214 is approximately equal to the CTE of fasteners 210. As used in the previous context, “approximately equal” means the CTE of fiber reinforced composite material 206 is within ± 5.0% of the CTE of fasteners 210.

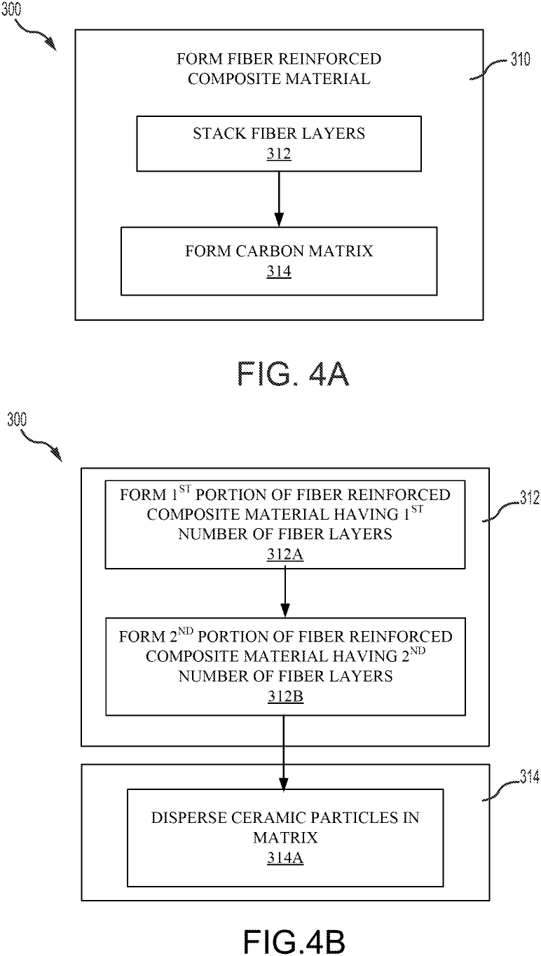

With reference to FIG. 4A, a method 300 of making a composite structure for use in conjunction with an aerospace component having a target CTE is illustrated. In various embodiments, method 300 may include forming a fiber reinforced composite having a CTE approximately equal to the target CTE (step 310). In various embodiments, step 310 may include stacking a plurality of fiber layers (step 312) and forming a carbon matrix surrounding the plurality of fiber layers (step 314). The plurality of fiber layers includes a plurality of carbon fibers and a plurality of non-carbon fibers. In various embodiments, step 312 may include interleaving a plurality of carbon fiber layers with a plurality of non-carbon fiber layers.

In various embodiments, step 310 may further include forming one or more of the fiber layers of by weaving together a non-carbon fiber tow and a carbon fiber tow. In various embodiments, step 310 may further include forming each of the fiber layers by weaving together a carbon fiber tow and a non-carbon fiber tow. In various embodiments, step 312 may include interleaving a plurality of carbon fiber layers with a plurality of non-carbon fiber layers.

With reference to FIG. 4B, in various embodiments, step 312 includes forming a first portion of the fiber reinforced composite material having a first number of fiber layers (step 312A), and forming a second portion of the fiber reinforced composite material having a second number of fiber layers greater than the first number of fiber layers (step 312B). In various embodiments, the second portion of the fiber reinforced composite material comprises a CTE that is approximately equal to the target CTE. In various embodiments, step 314 may include dispersing a plurality of ceramic particles in the carbon matrix.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A composite structure, comprising:
a fiber reinforced composite material including:
a plurality of fiber layers; and
a carbon matrix surrounding the plurality of fiber layers;
wherein a first fiber layer of the plurality of fiber layers includes a first carbon fiber tow, and wherein a second fiber layer of the plurality of fiber layers includes a non-carbon fiber tow, the first carbon fiber tow has a first coefficient of thermal expansion, the non-carbon fiber tow has a second coefficient of thermal expansion that is greater than the first coefficient of thermal expansion.

2. The composite structure of claim 1, wherein the second fiber layer further includes a second carbon fiber tow having the first coefficient of thermal expansion.

3. The composite structure of claim 1, wherein the non-carbon fiber tow of the second fiber layer is at least one of a silicon carbide fiber or a silicon nitride fiber.

4. The composite structure of claim 1, wherein the plurality of fiber layers includes a plurality of carbon fiber layers interleaved with a plurality of non-carbon fiber layers, the plurality of carbon fiber layers including the first fiber layer, and the plurality of non-carbon fiber layers including the second fiber layer.

5. The composite structure of claim 1, wherein a first portion of the fiber reinforced composite material comprises a first number of fiber layers, and wherein a second portion of the fiber reinforced composite material comprises a second number of fiber layers greater than the first number of fiber layers.

6. The composite structure of claim 5, further comprising a fastener located through the second portion of the fiber reinforced composite material, wherein a coefficient of thermal expansion of the fiber reinforced composite material in the second portion of the fiber reinforced composite material is approximately equal to a coefficient of thermal expansion of the fastener.

7. The composite structure of claim 5, wherein a coefficient of thermal expansion of the fiber reinforced composite material in the first portion of the fiber reinforced composite material is different from a coefficient of thermal expansion of the fiber reinforced composite material in the second portion of the fiber reinforced composite material.

8. The composite structure of claim 1, further comprising a coating formed over the fiber reinforced composite material, wherein a coefficient of thermal expansion of the fiber reinforced composite material is approximately equal to a coefficient of thermal expansion of the coating.

9. The composite structure of claim 1, wherein a coefficient of thermal expansion of the fiber reinforced composite material is approximately zero.

10. A method of making a composite structure for use in conjunction with an aerospace component having a target coefficient of thermal expansion, the method comprising:
forming a fiber reinforced composite material by:
stacking a plurality of fiber layers, the plurality of fiber layers including a plurality of carbon fibers and a plurality of non-carbon fibers, the carbon fibers of the plurality of carbon fibers having a first coefficient of thermal expansion, and the non-carbon fibers of the plurality of non-carbon fibers having a second coefficient of thermal expansion, the second coefficient of thermal expansion being greater than the first coefficient of thermal expansion; and
forming a carbon matrix surrounding the plurality of fiber layers,
wherein a coefficient of thermal expansion of a least a portion of the fiber reinforced composite material is approximately equal to the target coefficient of thermal expansion of the aerospace component.

11. The method of claim 10, wherein a first fiber layer of the plurality of fiber layers includes a first carbon fiber tow having the first coefficient of thermal expansion, and wherein a second fiber layer of the plurality of fiber layers includes a non-carbon fiber tow having the second coefficient of thermal expansion.

12. The method of claim 11, further comprising forming the second fiber layer by weaving the non-carbon fiber tow with a second carbon fiber tow having the first coefficient of thermal expansion.

13. The method of claim 10, wherein stacking the plurality of fiber layers includes interleaving a plurality of carbon fiber layers with a plurality of non-carbon fiber layers.

14. The method of claim 10, further comprising forming each fiber layer of the plurality of fiber layers by weaving a carbon fiber tow having the first coefficient of thermal expansion with a non-carbon fiber tow having the second coefficient of thermal expansion.

15. The method of claim 10, wherein stacking the plurality of fiber layers includes:
forming a first portion of the fiber reinforced composite material having a first number of fiber layers; and
forming a second portion of the fiber reinforced composite material having a second number of fiber layers greater than the first number of fiber layers, wherein the second portion of the fiber reinforced composite material includes the coefficient of thermal expansion that is approximately equal to the target coefficient of thermal expansion of the aerospace component.

16. The method of claim 10, wherein the aerospace component is formed of at least one of a metal or a metal alloy.

17. The method of claim 10, further comprising dispersing a plurality of ceramic particles in the carbon matrix of the fiber reinforced composite material.

18. An aerospace component, comprising:
a first structure formed of a first material, the first material comprising at least one of a metal or a metal alloy; and
a fiber reinforced composite structure mounted to the first structure, wherein a coefficient of thermal expansion of the fiber reinforced composite structure is approximately equal to a coefficient of thermal expansion of the first material.

19. The aerospace component of claim 18, wherein the fiber reinforced composite structure includes:
a plurality of carbon fibers;
a plurality of second fibers having a coefficient of thermal expansion greater than a coefficient of thermal expansion of the plurality of carbon fibers; and
a carbon matrix surrounding the plurality of carbon fibers and the plurality of second fibers.

20. The aerospace component of claim 19, further comprising a plurality of ceramic particles dispersed in the carbon matrix.
